(19) United States
(12) Patent Application Publication
(10) Pub. No.: US 2008/0160985 A1
(43) Pub. Date: Jul. 3, 2008

(54) LOCATION BASED DIALING OVER WIRELESS MEDIA

(76) Inventors: Girish S. Variyath, Cupertino, CA (US); Vikram Jayaraman, San Jose, CA (US); Rajneesh Kumar, San Jose, CA (US); Aseem B. Asthana, San Jose, CA (US); Ashish Chotai, Santa Clara, CA (US); Sravan Vadlakonda, Sunnyvale, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/619,590

(22) Filed: Jan. 3, 2007

(51) Int. Cl. H04Q 7/20

(52) U.S. Cl. 455/422.1

(57) ABSTRACT

In one embodiment, a first endpoint initiates a voice communication with an undetermined second endpoint. A second endpoint is selected that is within a predetermined proximity of a location and voice communication between the first s endpoint and the second endpoint is initiated. The second endpoint may be selected based on preset conditions, such as for example a buddy list definition.

### BACKGROUND

The first voice transmission sent by Alexander Graham Bell was accomplished in 1876 through what is called a ring down circuit. A ring down circuit does not require the dialing of numbers. Instead, a physical wire is connected to two devices. Basically, one person picks up a phone and another person was on the other end, no ringing was involved.

Over time, this simple design evolved from a one-way voice transmission, where only one user at a time could speak, to a bidirectional voice transmission system whereby both users could speak. Eventually, wireless voice communications were developed. Cellular networks provide wireless voice communications capability. Wireless Local Area Networks (WLANs) provide wireless networking capabilities, such as the ability to send and receive data. WLAN capabilities have been expanded to provide voice communications capabilities as well as data communication capabilities. Protocols such as Voice over Internet Protocol (VoIP) are employed to provide voice capabilities on WLANs.

In a wired network, the location of the endpoints of a telephone call is usually known. Typically, the point of attachment for each endpoint can be determined. However, for wireless and cellular networks, the location of the endpoints can be constantly changing.

### OVERVIEW OF EXAMPLE EMBODIMENTS

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an example embodiment, there is disclosed herein a method comprising receiving a request to initiate a voice communication from a first endpoint for an undetermined second endpoint. A second endpoint is selected that is within a proximity of a predetermined location. Voice communication is initiated between the first endpoint and the second endpoint.

In an example embodiment, there is disclosed herein an apparatus comprising a call manager configured to establish a voice communication, the call manager comprising a telephony endpoint tracker. The telephony endpoint tracker is responsive to the call manager receiving a request to initiate a voice communication from a first endpoint to an undetermined second endpoint to select a second endpoint that is within a predetermined proximity of a predetermined location and the call manager is responsive to attempt to establish voice communication between the first endpoint and the second endpoint.

In an example embodiment, there is disclosed herein an apparatus comprising means for receiving a request to initiate a voice communication from a first endpoint for an undetermined second endpoint. The apparatus further comprises means for selecting a second endpoint that is within a predetermined proximity of a predetermined location responsive to the means for receiving a request. The apparatus includes a means for initiating voice communication between the first endpoint and the second endpoint.

Still other objects of the present invention will become readily apparent to those skilled in this art from the following description wherein there is shown and described a preferred embodiment of this invention, simply by way of illustration of at least one of the best modes best suited to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate examples of the present invention, and together with the description serve to explain the principles of the invention.

FIG. 1 is an example embodiment of a system employing a location server for location based services.

FIG. 2 is an example embodiment of a system that implements location based services without a location server.

FIG. 3 is an example embodiment of a system that implements location based services utilizing dialing zones.

FIG. 4 is an example signal diagram for an example embodiment.

FIG. 5 is an example method providing location based dialing.

FIG. 6 is an example of a computer system for implementing an embodiment.

### DESCRIPTION OF EXAMPLE EMBODIMENTS

This description provides examples not intended to limit the scope of the invention, as claimed. The figures generally indicate the features of the examples, where it is understood and appreciated that like reference numerals are used to refer to like elements.

Described herein is an implementation that uses location services, such as the 802.11 location service, to create dialing plans and buddy lists, whose membership can dynamically change based on specified location criterion. As one example, a dialing list can be created on an IP-PBX/PTT (Internet Protocol Private Branch Exchange/Push-to-Talk) server based on specified location criterion. The dialing plans or buddy list could be in form of numeral digits or other alphanumeric forms such as a Sesssion Initiation Protocol Universal Resource Indicator (SIP URI) (e.g people@building14-4thfloor.cisco.com )As another example, a user can define a plan, such as a group plan, to initiate a voice communication with another user with a given set of attributes based on proximity to a specified location (e.g., dial “*5” to reach user(s) nearest to the user initiating the voice communication, nearest to a specified location or one or more users within a specified area).

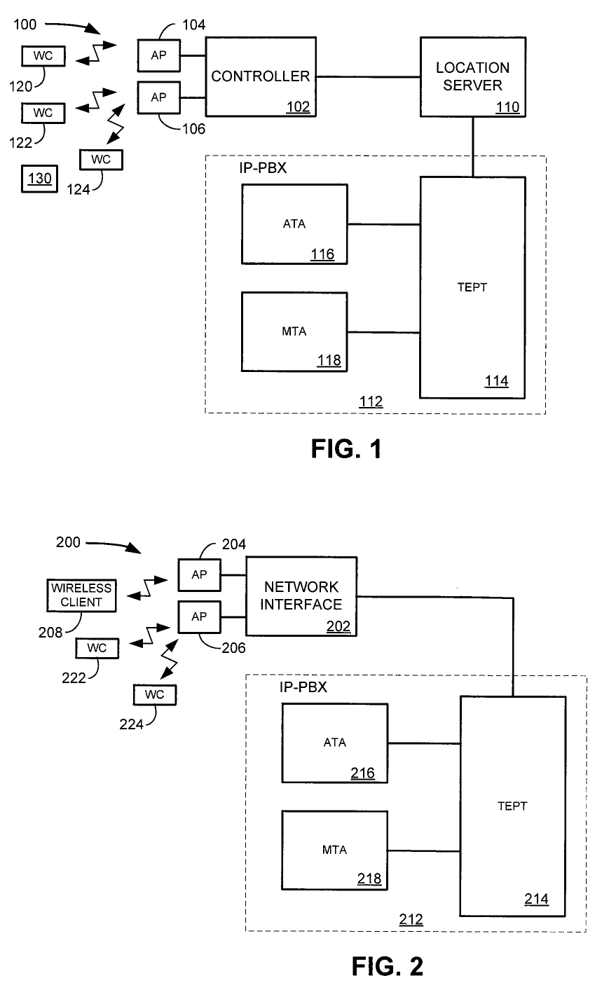

FIG. 1 is an example embodiment of a system 100 employing a location server 110 for location based services. Access points 104, 106 provide access to a wireless local area network (WLAN). In the illustrated example, wireless client (WC) 120 is associated with access point (AP) 104 and wireless clients 122, 124 are associated with access point 106. Wireless clients 120, 122, 124 are capable of functioning as telephony endpoints. The number of wireless clients associated with access points and number of access points in the WLAN should not be construed as limited to those illustrated in FIG. 1, but can be any physically realizable number. Access points 104, 106 are coupled to controller 102, which is coupled to location server (which can also be referred to as a Location Services Server or “LSS”) 110. Call manager 112, which in this example is an IP-PBX (Internet Protocol Private Branch Exchange), comprises a telephony endpoint tracker “TEPT” 114. TEPT 114 maintains an Alias to Telephony Translation Table (ATA) 116 and is coupled to a Media Access Control (MAC) address to Telephony Address Translation Table (MTA) 118.

The functionality for the operation of wireless clients 120, 122, 124, access points 104, 106, controller 102, location server 110, call manager 112 and TEPT 114 may be embodied in logic. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software.

Location server 110 acquires location data of endpoints, such as wireless clients 120, 122, 124 from controller 102. Controller 102 can determine the location of wireless clients by any suitable means. For example, controller 102 can receive received strength signal indication (RSSI) data and/or angle or arrival (AOA) data from access points 104, 106, or wireless clients can acquire their location data themselves via global positioning satellites (GPS) or other means and transmit the data to the WLAN. In an example embodiment, controller 102 can calculate the current position of wireless clients 120, 122, 124 based on the data acquired from access points 104, 106, which controller 102 can communicate with location server 110, or alternatively, controller 102 can pass the data on to location server 110 that enables location server 110 to calculate the current position of wireless clients 120, 122, 124. Location server 110 maintains data representative of the location of wireless clients 120, 122, 124.

In an example embodiment, TEPT 114 communicates with Location Server 110 and requests Location Server 110 track and report the location of telephony endpoints, such as Personal Digital Assistants (PDAs), Internet Protocol (IP) Phones, dual mode phones, etc., which can be represented by wireless clients 120, 122, 124, which the TEPT is interested in. TEPT 114 can also receive alerts from Location Server 110 based on certain location criteria, examples of which will be described herein infra. TEPT 114 posts updates to IP-PBX 112 about the entry and exit of endpoints meeting a specified criterion (e.g. members of a predefined group), which IP-PBX 112 uses to update one or more dialing plans.

TEPT 114 is a logical entity that is tightly integrated with IP-PBX 112 with a common communications interface to enable the exchange of a variety of information such as events, alerts and configuration between the two entities 114, 112. TEPT 114 can be provided with access to aspects of IP-PBX 112 configuration features, such as defining telephony aliases for a variety of levels (e.g. user level, device level or PBX-wide).

In an example embodiment, an interface can be defined for communications between TEPT 114 and Location Server 110. For example, the interface can include a means for TEPT 114 to request and receive information about the area that Location Server 110 covers. In large networks which may suitably comprise a plurality of location servers, TEPT 114 can acquire area information from one or more location servers covering an area of interest for TEPT 114. TEPT 114 can specify the particular area by providing data representative of the area such as coordinates of the area, labels used by location server 310, or other methods such as geo-priv, a proprietary format used by Cisco Systems, Inc., 170 West Tasman Drive, San Jose, Calif. The granularity of the location information may vary depending upon the implementation. For example, location server 110 may store high level floor plans, such as “building 14, first floor,” “east wing,” etc. Typically information about coverage areas will occur when systems are being initialized. Once initialized, location server 110 can notify TEPT 114 of subsequent updates to floor plans.

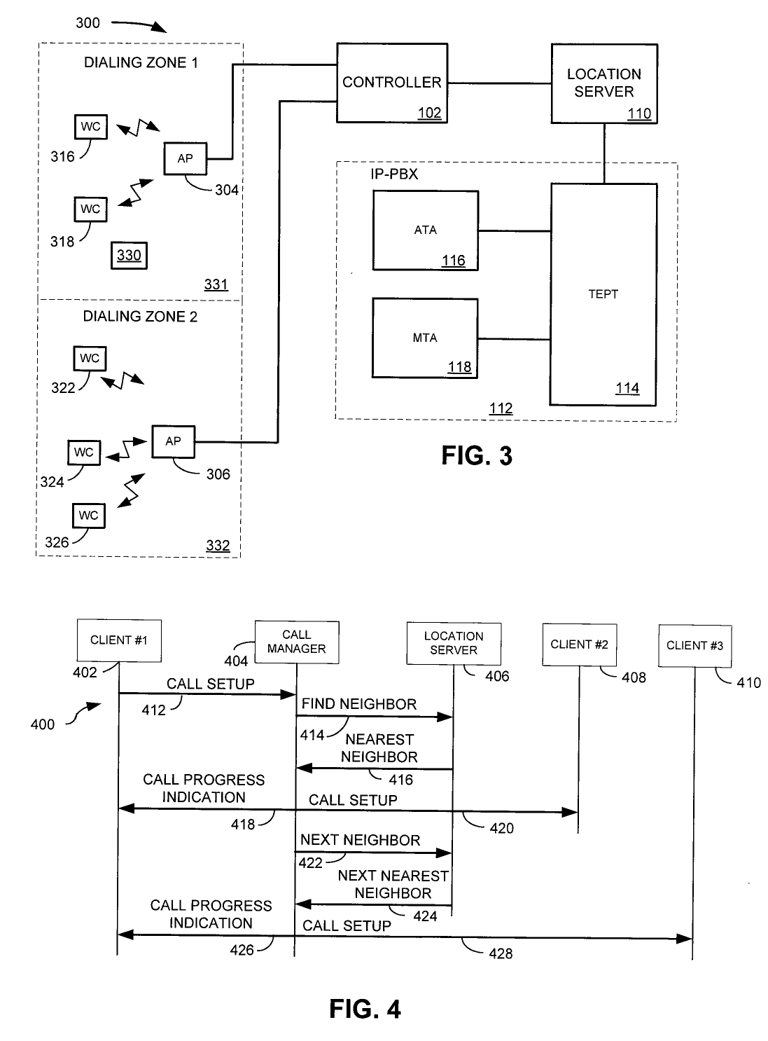

TEPT 114 can request location server 110 for data representative of a group of wireless clients within a particular area. For example, as will be described herein in FIG. 3, TEPT 114 can request all clients within a predefined area or zone. As another example, TEPT 114 can request location server 110 provide it with endpoints that are nearest to a particular point, such as nearest to a wireless client initiating a voice communication or a particular location, e.g. is location 130. Furthermore, TEPT 114 can request location server 110 limit the result to an endpoint or endpoints that have a particular attribute, such as a group membership, type of device, job function, etc.

For example, wireless client 120, associated with AP 104 may desire to communicate with the nearest endpoint. The request from wireless client 102 is forwarded to call manager 112. TEPT 114 then requests location server 110 provide the nearest endpoint to wireless client 120, which in this example is wireless client 122. Call manager 112 then attempts to establish the voice communication (e.g. a telephony call or a push to talk session) between wireless client 120 and wireless client 122.

Optionally, call manager 112 can be configured to abort the voice communication between wireless client 120 and wireless client 122 if it is unable to establish the voice communication within a predefined time period, and attempt to initiate a voice communication with the next nearest neighbor. For example, if wireless client 122 is busy or doesn't answer within three rings, call manager aborts attempting to establish a communications session between wireless client 120 and wireless client 122 and requests location server 110 provide the next nearest neighbor.

In an example embodiment, TEPT 114 can request location server 110 filter results by a specified parameter. For example, provide the nearest member to wireless client 120 that belongs to a predefined group. For example if wireless clients 120 and 124 belong to a first group, and wireless client 122 belongs to a second group, if wireless client 120 requests a voice communication with the nearest endpoint belonging to the same group, then TEPT 114 requests location server 110 provide the nearest neighbor belonging to group 1, which would be wireless client 124. If however, wireless clients 120, 122, 124 belong to the same group, the nearest neighbor returned by location server 110 to TEPT 114 would be wireless client 122.

In an example embodiment, TEPT 114 can request location server 110 provide the nearest wireless client to a specified location. The specific location can be any predefined location, such as nearest to a piece of equipment, computing device, etc. For example, if wireless client 120 wants to initiate a voice communication with an endpoint that is nearest to location 130, the result from location server 110 to TEPT 114 would be wireless client 124. Optionally, the nearest endpoint can be filtered by group membership or some other specified parameter. For example, if wireless clients 120, 122 belong to a first group and wireless client 124 belongs to a second group, then if wireless client 120 initiates a voice communication to the member of the first group nearest location 130, the result from location server 110 to TEPT 114 would be wireless client 122, even though wireless client 124 is closer to location 130 because wireless client is the nearest neighbor belonging to group 1.

In an example embodiment, wireless clients can maintain dialing plans with call manager 112. Alias translation table (ATA) 116 can be employed to store dialing plans for a wireless client. For example, wireless client 120 can request a dialing plan be created that contains the nearest endpoint belonging to the same group. ATA 116 would maintain an entry for the nearest neighbor to wireless client 120 that can be dynamically updated. For example, as illustrated in FIG. 1, wireless client 122 is the nearest neighbor to wireless client 120. Thus, ATA 116 would store wireless client 120 as the nearest neighbor to wireless client 120. When TEPT 114 receives an update from location server 110 that another wireless client is the nearest neighbor, TEPT 114 updates ATA 116 accordingly.

In an example embodiment, location server 110 sends TEPT 114 an identifier for the specified endpoint. For example, location server 110 may send TEPT 114 the MAC (Media Access Control) address. TEPT 114 can use a suitable table, such as a MAC address to Telephony Address Translation Table (MTA) 118 to identify the phone number or SIP URI for the endpoints. Once TEPT 114 knows the appropriate phone number, or SIP URI, TEPT 114 can initiate the voice communication, e.g. establish a voice call, conference call or send a Short Message Service (SMS) message, etc. In an example embodiment, where TEPT 114 is coupled to ATA 116, TEPT 114 can use MTA 118 to translate the results from location server 110 before storing the result in ATA 116.

Example applications of the example embodiment of FIG. 1 will now be described. The following examples are merely illustrative of applications the example embodiment of FIG. 1 is capable of performing and should not be construed as limited to only these examples. In one example, law enforcement personnel may desire to communicate (e.g. a push to talk session) with the nearest law enforcement officer, or security personnel in or near a certain area. For example a police officer may desire to communicate with either the nearest police officer to the officer's present location or with the nearest police officer to an area under surveillance. Building supervision or maintenance personnel can send an SMS to WiFi phones of all people near a certain area to order an emergency evacuation. In a factory setting, a supervisor can program a fixed number to an attendant's phone and by dialing the fixed number reach the attendant, no matter who is currently performing that function. In a healthcare setting, a nurse can dial a pre-programmed number to reach the nearest nurse or other health care professional. The example embodiment of FIG. 1 enables any user to create a list based on location, such as the user's current location or a fixed location, to reach a nearest or group of nearest users. Optionally, the user can filter the list by a group membership (e.g. a police officer can filter the list at an emergency situation to only communicate with other police officers and not fire or emergency medical personnel). The embodiment of FIG. 1 can implement the aforementioned examples.

FIG. 2 is an example embodiment of a system 200 that implements location based services without a location server. Access points 204, 206 provide access to a wireless local area network (WLAN). In the illustrated example, wireless client 208 is associated with access point (AP) 204 and wireless clients (WC) 222, 224 are associated with access point 206. Wireless clients 220, 222, 224 are capable of functioning as telephony endpoints. The number of wireless clients associated with access points and number of access points in the WLAN should not be construed as limited to those illustrated in FIG. 2, but can be any physically realizable number. Access points 204, 206 are coupled to a Network Interface (e.g. a controller or any other device capable of providing communications between the WLAN and call manager 212) 102. Call manager 212, which in this example is an IP-PBX (Internet Protocol Private Branch Exchange), comprises a telephony endpoint tracker “TEPT” 214. TEPT 214 maintains an Alias to Telephony Translation Table (ATA) 216 and is coupled to a Media Access Control (MAC) address to Telephony Address Translation Table (MTA) 218.

In this example embodiment, the location data provided to call manager 212 and TEPT 214 is which AP (e.g. AP 204, 206) a wireless client (e.g. clients 208, 222, 224) is currently associated. The location data is provided to call manager 212 via network interface 202. Network interface 202 tracks and reports the location of telephony endpoints, such as Personal Digital Assistants (PDAs), Internet Protocol (IP) Phones, dual mode phones, etc., represented by wireless clients 208, 222, 224, which TEPT 214 is interested in. TEPT 214 can also receive alerts from Network Interface 202 on certain location criteria, such as when one of wireless clients 208, 222, 224 roam to another AP. TEPT 214 posts updates to IP-PBX 212 about the entry and exit of endpoints meeting a specified criterion (e.g. members of a predefined group), which IP-PBX 112 uses to update one or more dialing plans.

TEPT 214 is a logical entity that is tightly integrated with IP-PBX 212 with a common communications interface to enable the exchange of a variety of information such as events, alerts and configuration between the two entities 214, 212. TEPT 214 can be provided with access to aspects of IP-PBX 212 configuration features, such as defining telephony aliases for a variety of levels (e.g. user level, device level or PBX-wide).

TEPT 214 can request via the network interface 202 data representative of a group of wireless clients associated with a particular AP. For example, TEPT 214 can request all clients associated with AP 206. Furthermore, TEPT 214 can request limit the results to an endpoint or endpoints that have a particular attribute, such as a group membership, type of device, job function, etc.

For example, wireless client 222, associated with AP 204 may desire to communicate with endpoints associated with AP 206. The request from wireless client 208 is forwarded to call manager 212. TEPT 214 then determines the wireless clients 222, 224 that are associated with AP 206. Call manager 112 then attempts to establish the voice communication (e.g. a telephony call, SMS or push to talk session) between wireless client 208 and wireless clients 222, 224.

In an example embodiment, TEPT 214 can filter results by a specified parameter. For example, provide wireless clients that belong to a predefined group associated with AP 206. For example if wireless clients 208 and 224 belong to a first group, and wireless client 222 belongs to a second group, if wireless client 220 requests a voice communication with endpoints belonging to the same group that are associated with AP 206, then TEPT 214 will provide the nearest neighbor (or neighbors) belonging to group 1, which in this example would be wireless client 224.

In an example embodiment, wireless clients can maintain dialing plans with call manager 212. Alias translation table (ATA) 216 can be employed to store dialing plans for a wireless client.

In an example embodiment, network interface 202 sends TEPT 214 an identifier for a specified endpoint. For example, network interface 202 may send TEPT 214 the MAC address of an endpoint. TEPT 214 can use a suitable table, such as MTA 218 to identify the phone number or SIP URI for the endpoint. Once TEPT 214 knows the appropriate phone number, or SIP URI, TEPT 214 can initiate the voice communication, e.g. establish a voice call, conference call or send a Short Message Service (SMS) message, a push-to-talk (PTT) communication, etc. In an example embodiment, where TEPT 214 is coupled to ATA 216, TEPT 214 can use MTA 218 to translate the results from network interface 202 before storing the result in ATA 216.

FIG. 3 is an example embodiment of a system 300 that implements location based services utilizing dialing zones. Access points 304, 306 provide access to a wireless local area network (WLAN). In this example, AP 304 is in dialing zone 1 331 and AP 306 is in dialing zone 2 332.Wireless clients (WC) 316, 318 are associated with access point (AP) 304 and wireless clients 322, 324, 326 are associated with access point 306. Wireless clients 316, 318, 322, 324, 326 are capable of functioning as telephony endpoints. The number of wireless clients associated with access points and number of access points in the WLAN should not be construed as limited to those illustrated in FIG. 3, but can be any physically realizable number. Access points 304, 306 are coupled to controller 102, which is coupled to location server (which can also be referred to as a Location Services Server or “LSS”) 110. Call manager 112, which in this example is an IP-PBX (Internet Protocol Private Branch Exchange), comprises a telephony endpoint tracker “TEPT” 114. TEPT 114 maintains an Alias to Telephony Translation Table (ATA) 116 and is coupled to a Media Access Control (MAC) address to Telephony Address Translation Table (MTA) 118. The functionality for the operation of wireless clients 316, 318, 322, 324, 326 and access points 304, 306 may be embodied in logic.

Location server 110 acquires location data of endpoints, such as wireless clients 316, 318, 322, 324, 326 from controller 102. Controller 102 can determine the location of wireless clients by any suitable means. For example, controller 102 can receive received strength signal indication (RSSI) data and/or angle or arrival (AOA) data from access points 304, 306, or wireless clients can acquire their location data themselves via global positioning satellites (GPS) or other means and transmit the data to the WLAN. In an example embodiment, controller 102 can calculate the current position of wireless clients 316, 318, 322, 324, 326 based on the data acquired from access points 304, 306, which controller 102 can communicate with location server 110, or alternatively, controller 102 can pass the data on to location server 110 that enables location server 110 to calculate the current position of wireless clients 120, 122, 124. Location server 110 maintains data representative of the location of wireless clients 120, 122, 124.

TEPT 114 can request location server 110 for data representative of a group of wireless clients within a particular area. For example, as will be described herein in FIG. 3, TEPT 114 can request all clients within a predefined area or zone (e.g. zone 331 or 332). As another example, TEPT 114 can request is location server 110 provide it with endpoints that are nearest to a particular point, such as nearest to a wireless client initiating a voice communication or a particular location, e.g. location 130. Furthermore, TEPT 114 can request location server 110 limit the result to an endpoint or endpoints that have a particular attribute, such as a group membership, type of device, job function, etc.

For example, wireless client 316, associated with AP 304 may desire to communicate with the nearest endpoint. The request from wireless client 316 is forwarded to call manager 112. TEPT 114 then requests location server 110 provide the nearest endpoint to wireless client 316, which in this example is wireless client 318. Call manager 112 then attempts to establish the voice communication (e.g. a telephony call or a push to talk session) between wireless client 316 and wireless client 318.

Optionally, call manager 112 can be configured to abort the voice communication between wireless client 316 and wireless client 318 if it is unable to establish the voice communication within a predefined time period, and attempt to initiate a voice communication with the next nearest neighbor. For example, if wireless client 318 is busy or doesn't answer within three rings, call manager 112 aborts attempting to establish a communications session between wireless client 316 and wireless client 318 and requests location server 110 provide the next nearest neighbor, which in this example would be wireless client 322.

In an example embodiment, TEPT 114 can request location server 110 filter results by a specified parameter. For example, provide the nearest member to wireless client 316 that belongs to a predefined group. For example if wireless clients 316 and 322 belong to a first group, and wireless client 318 belongs to a second group, if wireless client 316 requests a voice communication with the nearest endpoint belonging to the same group, then TEPT 114 requests location server 110 provide the nearest neighbor belonging to group 1, which would be wireless client 322. If however, wireless clients 316, 318, 322 belong to the same group, the nearest neighbor returned by location server 110 to TEPT 114 would be wireless client 318.

In an example embodiment, TEPT 114 can request location server 110 provide the nearest wireless client to a specified location. The specific location can be any predefined location, such as nearest to a piece of equipment, computing device, etc. For example, if wireless client 316 wants to initiate a voice communication with an endpoint that is nearest to location 330, the result from location server 110 to TEPT 114 would be wireless client 322. Optionally, the nearest endpoint can be filtered by group membership or some other specified parameter. For example, if wireless clients 316, 318 belong to a first group and wireless client 322 belongs to a second group, then if wireless client 316 initiates a voice communication to the member of the first group nearest location 330, the result from location server 110 to TEPT 114 would be wireless client 318, even though wireless client 322 is closer to location 330 because wireless client is the nearest neighbor belonging to group 1.

In an example embodiment, wireless clients can maintain dialing plans with call manager 112. Alias translation table (ATA) 116 can be employed to store dialing plans for a wireless client. For example, wireless client 316 can request a dialing plan be created that contains the nearest endpoint belonging to the same group. ATA 116 would maintain an entry for the nearest neighbor to wireless client 316 that can be dynamically updated. For example, as illustrated in FIG. 1, wireless client 318 is the nearest neighbor to wireless client 316. Thus, ATA 116 would store wireless client 316 as the nearest neighbor to wireless client 316. When TEPT 114 receives an update from location server 110 that another wireless client is the nearest neighbor, TEPT 114 updates ATA 116 accordingly.

In an example embodiment, TEPT 314 will request location server 110 notify TEPT 314 about all endpoints in a particular area, such as dialing zones 331, 332 which are depicted in FIG. 3. TEPT 314 can specify the particular area by providing data representative of the area such as coordinates of the area, labels used by location server 110, or other methods such as geo-priv, a proprietary format used by Cisco Systems, Inc., 170 West Tasman Drive, San Jose, Calif. After receiving the request, location server 110 provides a list of endpoints in the particular area and changes to the particular area, such as endpoints entering and/or exiting the particular area. In an example embodiment, endpoints that are trackable by TEPT 314 can be identified at the time of their association with the WLAN by using a Telephony Trackable IE (Information Element) in the association request. Location server 110 can filter which endpoints are reported to TEPT 314 by the IE.

In an example embodiment, location server 110 provides a list of MAC addresses and an identifier identifying the particular area. Location server 110 can provide updates to TEPT 314. A code can be used to indicate whether an endpoint has moved into the particular area or left the particular area. For example, when a particular area is first specified by TEPT 314, location server 110 can provide a list that will contain the MAC address of all wireless clients (or Telephony Trackable wireless clients) presently in the area. Subsequent updates would contain the MAC address of wireless clients that have either entered or left the area. For example, wireless client 316 can request a list of all wireless clients in zone 331. As illustrated in FIG. 3, the list would comprise wireless client 318. If wireless client 318 left zone 331, e.g. moves into zone 332, then wireless client 318 would be removed from the list. If another wireless client, e.g. wireless client 322 moves into zone 331, then it would be added to the list. A list of wireless clients by zone can also be filtered by a specified parameter, such as group membership. For example, if a supervisor is using wireless client 326, and wireless client 322 is a subordinate to wireless user 326, but wireless client 324 is not, then wireless client 326 can create a list of all subordinates in zone 332 which would comprise wireless client 322, but not wireless client 324. The list can be updated as group users move into and out of zone 332.

As an example application of system 300, most health care facilities have a predefined group of responders for certain emergencies such as cardiac arrest. If a patient in zone 332 were to go into cardiac arrest, then all members of the group can be alerted. As another example, building supervision or security personnel can dial a group number to reach all users within a zone, for example all WiFi phones, to evacuate an area. These, and other capabilities too numerous to be listed herein are provided by the example embodiment of FIG. 3.

In an example embodiment, location server 110 sends TEPT 114 an is identifier for the specified endpoint. For example, location server 110 may send TEPT 114 the MAC (Media Access Control) address. TEPT 114 can use a suitable table, such as a MAC address to Telephony Address Translation Table (MTA) 118 to identify the phone number or SIP URI for the endpoints. Once TEPT 114 knows the appropriate phone number, or SIP URI, TEPT 114 can initiate the voice communication, e.g. establish a voice call, conference call or send a Short Message Service (SMS) message, etc. In an example embodiment, where TEPT 114 is coupled to ATA 116, TEPT 114 can use MTA 118 to translate the results from location server 110 before storing the result in ATA 116.

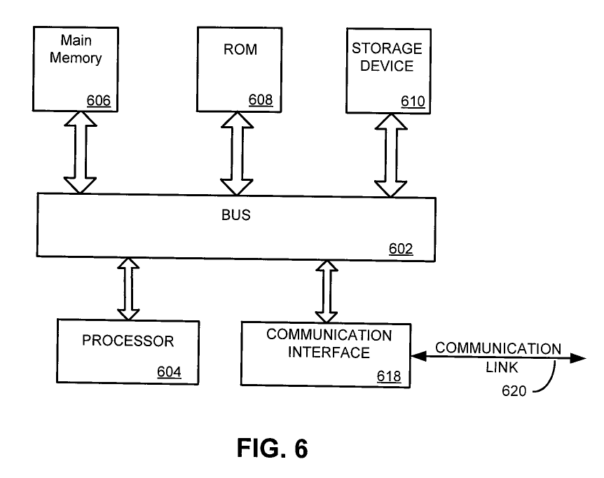

FIG. 6 is a block diagram that illustrates a computer system 600 upon which an embodiment of the invention may be implemented. Computer system 600 includes a bus 602 or other communication mechanism for communicating information and a processor 604 coupled with bus 602 for processing information. Computer system 600 also includes a main memory 606, such as random access memory (RAM) or other dynamic storage device coupled to bus 602 for storing information and instructions to be executed by processor 604. Main memory 606 also may be used for storing a temporary variable or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 can be employed for location based dialing. Computer system 600 can be employed to control the operation of wireless clients access points controllers location servers call managers TEPTs described herein to implement location based dialing. According to one embodiment of the invention, location based dialing is provided by computer system 600 in response to processor 604 executing one or more sequences of one or more instructions contained in main memory 606. Such instructions may be read into main memory 606 from another computer-readable medium, such as storage device 610. Execution of the sequence of instructions contained in main memory 606 causes processor 604 to perform the process steps described herein. One or more processors in a multi-processing arrangement may also be employed to execute the sequences of instructions contained in main memory 606. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to non-volatile media, volatile media, and transmission media. Non-volatile media include for example optical or magnetic disks, such as storage device 610. Volatile media include dynamic memory such as main memory 606. Transmission media include coaxial cables, copper wire and fiber optics, including the wires that comprise bus 602. Transmission media can also take the form of acoustic or light waves such as those generated during radio frequency (RF) and infrared (IR) data communications. Common forms of computer-readable media include for example floppy disk, a flexible disk, hard disk, magnetic cards, paper tape, any other physical medium with patterns of holes, a RAM, a PROM, an EPROM, a FLASHPROM, any other memory chip or cartridge, a carrier wave as described hereinafter, or any other medium from which a computer can read.

Various forms of computer-readable media may be involved in carrying one or more sequences of one or more instructions to processor 604 for execution. For example, the instructions may initially be borne on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector coupled to bus 602 can receive the data carried in the infrared signal and place the data on bus 602. Bus 602 carries the data to main memory 606 from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication between computer system 600 and other devices. Communication interface 618 may suitably any wired or wireless communication interface. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

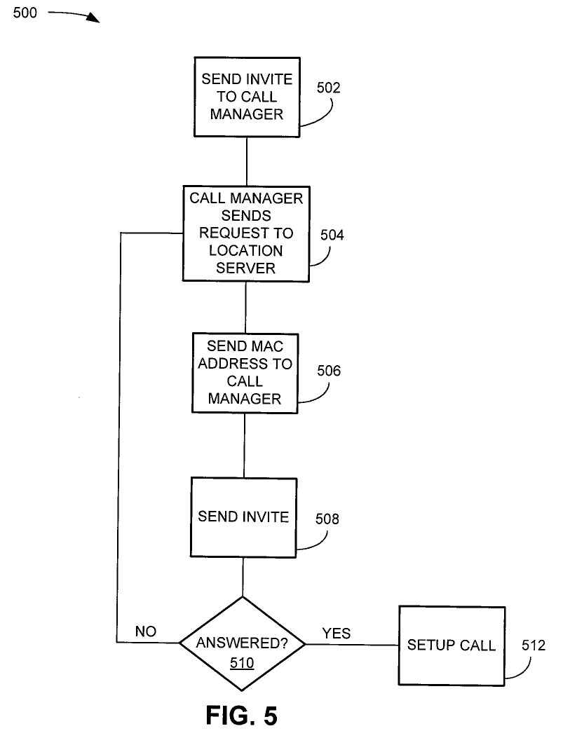

In view of the foregoing structural and functional features described above, a methodology in accordance with various aspects of the present invention will be better appreciated with reference to FIG. 5. While for purposes of simplicity of explanation, the methodology of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

Signal diagram 400 of FIG. 4 will illustrates an example of various signals 10 sent for the steps of FIG. 5. At 502, a client desiring to initiate a location based voice communication sends a request to the call manager, such as a SIP INVITE request. As illustrated at 412 in FIG. 4, a call setup (e.g. an INVITE) request is sent from client #1 402 to call manager 404. A call request may contain parameters identifying parameters for the desired endpoint. For example, the request may contain location data, such as call nearest neighbor to client #1, call nearest neighbor belonging to same group as client #1, call nearest neighbor to a specified location (e.g., a zone or within a predefined distance about a desired location), call all members of a group within a specified location (e.g., a zone or within a predefined distance about a desired location), etc.

At 504, the call manager sends a request to a location server for endpoints meeting the specified request. As illustrated in FIG. 4, call manager 404 sends a find neighbor request 414 to location server 406.

At 506, the location server sends the identity (e.g. the MAC address) of endpoints meeting the criteria. In the example illustrated by FIG. 4, location server 406 sends the NEAREST NEIGHBOR 416 to call manager 404. If the location server sends a non-telephony identifier (e.g. MAC address) for the endpoint, the call manager can employ a translation table (e.g. a MTA) to acquire the phone number, or SIP URI for the endpoint.

At 508, the call manager attempts to complete the voice communication. In the example illustrated in FIG. 4, call manager 404 performs call setup (e.g. sends an INVITE) 420 to the nearest neighbor (client #2 408 in this example) and a call progress indication (e.g., the called # such as the telephone number of SIP URI of client #2) 418 is communicated to client #1 402. Although not shown, call manager may also send other signals to client #1 402 used for setting up the voice communication, such as ring, busy, etc.

At 510, a determination is made whether the voice communication was completed. For example, call manager 404 can be configured to abort an attempt to establish a voice communication if the destination endpoint (e.g. client #2 408) is busy or does not answer the call within a predetermined time, for example within three rings. For example, if at 510 it is determined that the selected endpoint (e.g. client #2 408) is busy or did not answer within a predetermined time period (NO) then processing returns to step 504 wherein call manager 404 sends another request to location server 406 requesting the next nearest neighbor 424. At 506, an identifier (e.g. MAC address) of the next nearest neighbor is sent to the call manager. For example, in FIG. 4 a message comprising the next nearest neighbor 424 is sent from location server 406 to call manager 404. At 508, an invite message is sent to the next nearest neighbor. For example, FIG. 4 illustrates a call setup (e.g. an invite) message 428 is sent to the next nearest neighbor (client #3) 410 while the call progress indication (e.g. a called # such as the telephone number or SIP URI, etc.) 426 of the next nearest neighbor 410 is sent to client #1 402. Steps 504, 506, 508, 510 can be repeated until a voice communication is successfully completed. Once a call is successfully completed (YES) at 510, then at 512 any remaining call setup tasks are performed.

What has been described above includes example implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

1. A method, comprising:
receiving a request to initiate a voice communication from a first endpoint for an undetermined second endpoint;
selecting a second endpoint that is within a proximity of a predetermined location; and
initiating voice communication between the first endpoint and the second endpoint.

2. A method according to claim 1, wherein the request comprises a specified parameter.

3. A method according to claim 2, the selecting step comprises selecting the second endpoint from at least one other endpoint matching the specified parameter

4. A method according to claim 3, wherein the specified parameter is a group membership

5. A method according to claim 2, the selecting step further comprises selecting the second endpoint from a plurality of other endpoints matching the specified parameter, wherein the predetermined location is nearest to a current location of the first endpoint.

6. A method according to claim 5, further comprising:
aborting the voice communication between the first endpoint and the second endpoint when the voice communication is not completed within a predetermined time period;
selecting a third endpoint matching the specified parameter that is within a predetermined proximity of the first endpoint; and
initiating voice communication between the first endpoint and the third endpoint;
wherein the third endpoint is the next nearest endpoint to the first endpoint.

7. A method according to claim 2, the selecting step further comprises selecting the second endpoint from a plurality of other endpoints matching the specified parameter, wherein the proximity to a predetermined location is nearest to a specified location.

8. A method according to claim 1, further comprising:
the selecting step further comprises selecting all other endpoints within a predefined physical boundary; and
the initiating step further comprises initiating voice communication is with the first endpoint and all other endpoints within the predefined physical boundary.

9. A method according to claim 1, wherein the voice communication is one of a group consisting of a bidirectional telephony session and a push to talk session.

10. An apparatus, comprising:
a call manager configured to establish a voice communication comprising a telephony endpoint tracker;
wherein the telephony endpoint tracker is responsive to the call manager receiving a request to initiate a voice communication from a first endpoint to an undetermined second endpoint to select a second endpoint that is within a predetermined proximity of a predetermined location and the call manager is responsive to attempt to establish voice communication between the first endpoint and the second endpoint.

11. An apparatus according to claim 10, wherein the request comprises a specified parameter.

12. An apparatus according to claim 11, wherein the second endpoint is selected from a plurality of other endpoints matching the specified parameter, wherein the predetermined proximity of a predetermined location is nearest to a current location of the first endpoint.

13. An apparatus according to claim 12, further comprising:
the call manager is configured to abort the voice communication between the first endpoint and the second endpoint when the voice communication is not completed within a predetermined time period;
the telephony endpoint tracker is configured to select a third endpoint matching the specified parameter that is within a predetermined proximity of the first endpoint; and
initiating voice communication between the first endpoint and the is third endpoint;
wherein the third endpoint is the next nearest endpoint to the first endpoint.

14. An apparatus according to claim 11, the telephony endpoint tracker is configured to select the second endpoint from a plurality of other endpoints matching the specified parameter that is nearest to the predetermined location, wherein the predetermined location is a specified location.

15. An apparatus according to claim 10, further comprising:
an alias to telephony address table coupled to the telephony endpoint tracker;
wherein the telephony endpoint tracker is configured to select the second endpoint by requesting an identifier for the nearest endpoint to the predetermined location from a location server communicatively coupled to the call manager;
wherein the telephony endpoint tracker is responsive to receiving the identifier for the nearest endpoint to lookup the identifier in the alias to telephony address table to acquire a communication parameter for initiating communication with the second endpoint.

16. An apparatus according to claim 10, further comprising:
the telephony endpoint tracker is responsive to select all other endpoints within a predefined physical boundary; and
the call manager is configured to initiate voice communication with the first endpoint and all other endpoints within the predefined physical boundary.

17. An apparatus, comprising:
means for receiving a request to initiate a voice communication from a first endpoint for an undetermined second endpoint;
means for selecting a second endpoint that is within a predetermined proximity of a predetermined location; and
means for initiating voice communication between the first endpoint and the second endpoint.

18. An apparatus according to claim 17, further comprising:
the means for selecting further comprising means for selecting the second endpoint from a plurality of endpoints, wherein the predetermined location is a current location of the first endpoint and the second endpoint is the nearest endpoint of the plurality of endpoints to the current location of the first endpoint.

19. An apparatus according to claim 17, further comprising:
the means for selecting further comprising means for selecting the second endpoint from a plurality of endpoints, wherein the predetermined location is a specified location and the second endpoint is the nearest endpoint of the plurality of endpoints to the specified location.

20. An apparatus according to claim 17, further comprising:
the means for selecting further comprises means for selecting all other endpoints within a predefined physical boundary; and
the means for initiating step further comprises initiating voice communication with the first endpoint and the all other endpoints.
